(19) United States
(12) Patent Application Publication
(10) Pub. No.: US 2011/0004703 A1
(43) Pub. Date: Jan. 6, 2011

(54) ILLEGAL COMMAND HANDLING

(75) Inventors: Ibrahim MURTUZA, Sugar Land, TX (US); Binu John BABU, Houston, TX (US)

Correspondence Address: VOLPE AND KOENIG, P.C., UNITED PLAZA, 30 SOUTH 17TH STREET, PHILADELPHIA, PA, 19103, US

(73) Assignee: NANYA TECHNOLOGY CORPORATION, Tao-Yuan Hsien (TW)

(21) Appl. No.: 12/497,245

(22) Filed: Jul. 2, 2009

(51) Int. Cl. G06F 3/00

(52) U.S. Cl. 710/5

(57) ABSTRACT

A circuit for handling an illegal command embodies a control decode stage, illegal command handling stage and an output stage. The control decode circuit receives a clock signal, receives and decodes an external command, and latches the decoded external command based on the clock signal to generate a first signal. The first device is coupled to the control decode circuit for receiving the first signal, receives a second signal indicating whether the illegal command is detected in the external command, and generates a third signal based on the first and the second signals. The output circuit is coupled to the first device, receives the clock signal and the third signal, and generates a first output based on the clock signal and the third signal. If there is an illegal command, then there will be no control output generated. On the other hand, in the absence of an illegal command a control output will be generated.

### FIELD OF THE INVENTION

The present invention relates to a method and an apparatus for illegal command handling, and more particularly to illegal command handling at control decode stage.

### BACKGROUND OF THE INVENTION

According to the current circuit designs for illegal command handling, refer to FIG. 1 which is a schematic diagram showing a circuit 10 for illegal command handling known to this art, it can be observed that all the main components are placed in sequence. The circuit 10 comprises a control decode circuit 11, an illegal command handler 12, a full latch circuit 13, and a NOT gate 14. A command, such as READ, WRITE, or ACTIVATE command, is received by the control decode circuit 11. The control decode circuit 11 decodes the command CMD11 and transmits a first signal SG11 to the illegal command handler 12. The illegal command handler 12 receives and detects the first signal SG11, and transmits a second signal SG12 to the full latch circuit 13. The full latch circuit 13 receives the second signal SG12 and a clock signal CLK11 respectively, latches the second signal SG12 based on the clock signal CLK11 to produce a first output A11, and transmits the first output A11 to the NOT gate 14. Finally, the NOT gate converts the first output A11 to a command output CMD12.

FIG. 2 is a schematic diagram showing the waveforms in some paths of the abovementioned circuit 10 for illegal command handling, when the timing delay of each portion of the circuit is taken into account. According to FIG. 2, the original waveform of the command entering into the control decode circuit 11 is indicated as “CMD11” on top. And the waveforms of the first and the second signals are indicated as the “SG11” and “SG12” respectively. Due to the timing delay of the control decode circuit 11 and that of the illegal command handler 12, it can be observed that the timing of the first signal SG11 is after that of the command CMD11, and the timing of the second signal SG12 is also after that of the first signal SG11. Since the control decode circuit 11 and the illegal command handler 12 is allocated in sequence, the timing delays due to the two functional circuits would be accumulated and thus the timing of the second signal SG12 is after that of the command CMD11. If the accumulated timing delay in the circuit is too large so as to over a certain timing window, say a full period of the clock signal CLK11, there will be no output signal. Therefore, if one could not tighten the clock signal CLK11, one would have to slow down the clock to latch the second signal SG12 for generating a command output CMD12. In addition to those expected timing delays due to circuit design, there might be other timing issues due to process, voltage and temperature (PVT) variations.

Based on the current design, illegal command handling has been part of the critical path that has slowed down the critical path timing and eventually may end up with a malfunction or the inability to speed up the critical path. Therefore, there is a need to refine the circuit design as well as the method for illegal command handling.

### SUMMARY OF THE INVENTION

The present invention provides new circuit designs as well as a method for illegal command handling. In order to decrease the timing loss in the critical path, the circuit of the illegal command handling is removed to a separate path and its output is used as a control to allow the decoded command to pass through or not. The structure of the new circuit is designed to only have an insignificant timing increase while allowing a larger timing window.

In accordance with one aspect of the present preferred embodiments, a circuit for handling an illegal command is provided. The circuit comprises a control decode circuit, a first device and an output circuit. The control decode circuit receives a clock signal, receives and decodes an external command, and latches the decoded external command based on the clock signal to generate a first signal. The first device is coupled to the control decode circuit for receiving the first signal, receives a second signal from the illegal command handler indicating whether the illegal command is detected in the external command, and generates a third signal based on the first and the second signals. The output circuit is coupled to the first device, receives the clock signal and the third signal, and generates a first output based on the clock signal and the third signal. Preferably, the first device is a NAND gate, and the output circuit further comprises a second device converting the first output to a command output.

Preferably, the third signal lasts a period of a full cycle time of the clock signal.

Preferably, the clock signal has a negative edge and a positive edge, the control decode circuit latches the decoded external command on the negative edge, and the output circuit latches the third signal on the positive edge. Making sure that the wording used here is logical and making sense!

Preferably, the circuit for handling an illegal command further comprises a first input, a second input, and an illegal command handler. The first input provides the clock signal. The second input is also coupled to the control and decode circuit and provides the external command. The illegal command handler is coupled to the first and the second inputs, receives the clock signal and the external command respectively, and generates the second signal.

Preferably, the illegal command handler generates the second signal based on whether the illegal command is detected in the external command. The second signal is at a low level if the illegal command is detected in the external command, and the second signal is at a high level if no illegal command is detected in the external command.

In accordance with another aspect of the preferred embodiments, a circuit for handling an illegal command is provided. The circuit comprises a control decode circuit, an illegal command handler, and an output circuit. The control and decode circuit receives a clock signal, receives and decodes an external command, and generates a first signal. The illegal command handler receives the external command in parallel and generates a second signal based on whether the illegal command is detected in the external command. The output circuit is coupled to the control decode circuit and the illegal command handler respectively, receives the clock signal, the first and the second signals, and generates a first output based on the clock signal and the first and the second signals.

Preferably, the circuit further comprises a first input and a second input. The first input provides the clock signal and is coupled to the control decode circuit and the illegal command handler respectively. The second input provides the external command and is coupled to the control decode circuit and the illegal command handler respectively.

Preferably, the output circuit has a first device receiving the first and the second signals, and generating a third signals based on the first and the second signals, and the output circuit has a second device converting the first output to a command output.

In accordance with another aspect of the preferred embodiments, a method for illegal command handling is provided. The method comprises steps of: (a) receiving a clock signal and an external command; (b) decoding the external command; (c) latching the decoded external command based on the clock signal to generate a first signal; (d) receiving a second signal indicating whether an illegal command is detected in the external command; and (e) generating a first output based on the clock signal, the first and the second signals. Preferably, the step (e) further includes a sub-step of generating a third signal based on the first and the second signals.

Preferably, the third signal is generated based on the first signal if the second signal is at a high level, and the third signal is at a high level if the second signal is at a low level.

Preferably, the abovementioned step (e) further comprises a sub-step of latching the third signal based on the clock signal to generate the first output, wherein the third signal is latched on a positive edge of the clock signal.

Preferably, the method for illegal command handling further comprises a step of (f) converting the first output to a command output by inverting the first output.

Preferably, the method for illegal command handling further comprises following steps before the step (d): (c1) receiving the external command in a parallel route; (c2) detecting if there is an illegal command in the external command; and (c3) generating the second signal based on a detecting result of the step (c2).

### BRIEF DESCRIPTION OF THE DRAWINGS

FIG. 1 is a schematic diagram showing a circuit for illegal command handling known to this art;

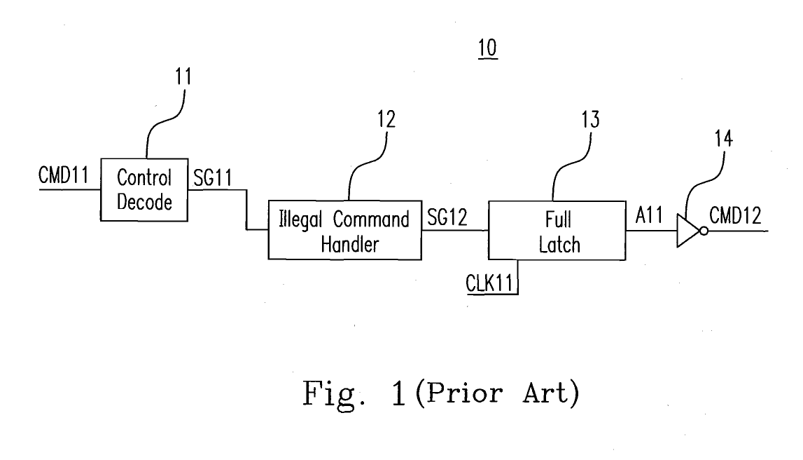

FIG. 2 is a schematic diagram showing the waveforms in some paths of the circuit for illegal command handling known to this art;

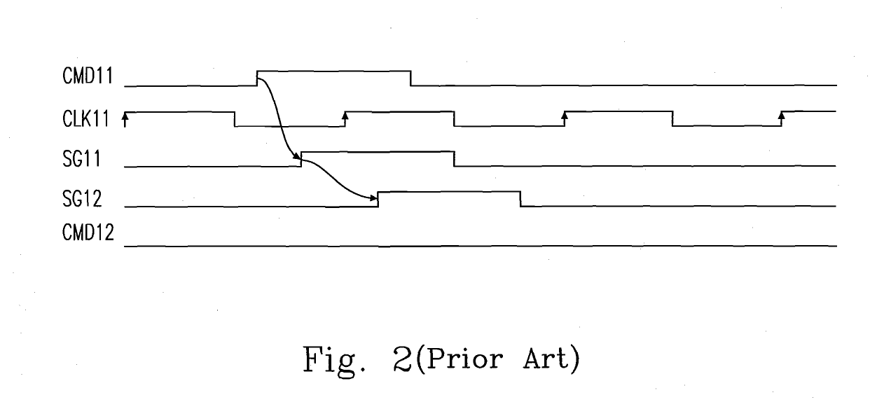

FIG. 3 is a schematic diagram showing a circuit for illegal command handling according to the present invention;

FIG. 4 is a schematic diagram showing the waveforms in some paths of the circuit for illegal command handling provided by the present invention; and

FIG. 5 is a schematic diagram showing a circuit 50 for illegal command handling according to another aspect of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

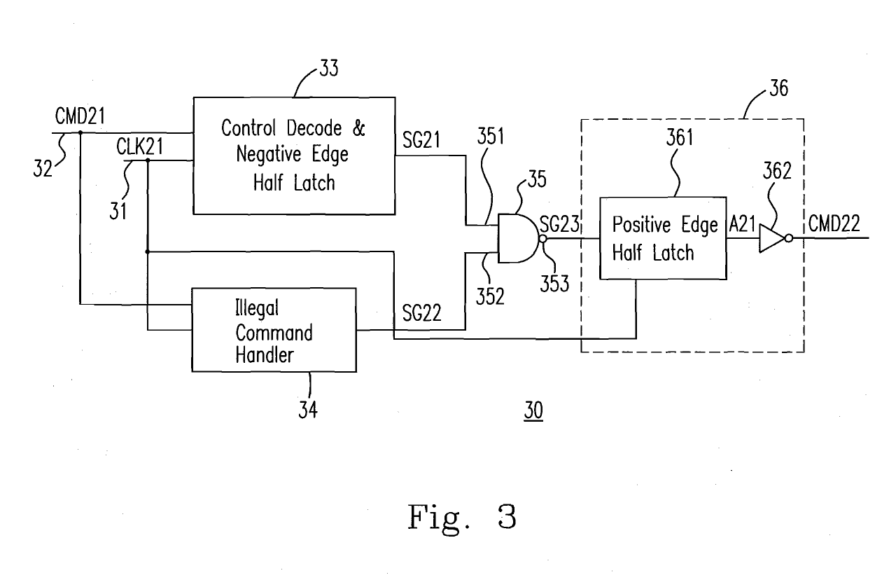

Please refer to FIG. 3, which is a schematic diagram showing a circuit 30 for illegal command handling according to the present invention. According to FIG. 3, a first input terminal 31 is coupled to a control decode circuit 33, an illegal command handler 34, and an output circuit 36 respectively, and a second input terminal 32 is coupled to the control decode circuit 33 and the illegal command handler 34 respectively. A first device 35 having two input terminals 351 and 352 and one output terminal 353, preferably a NAND gate, is coupled to the control decode circuit 33 and the illegal command handler 34 at the input terminals 351 and 352 respectively. The first device 35 is coupled to the output circuit 36. A clock signal CLK is provided to the first input terminal 31. The clock signal CLK is transmitted from the first input terminal 31 to the control decode circuit 33, the illegal command handler 34 and the output circuit 36 respectively. An external command CMD21 is provided to the second input terminal 32, and the control decode circuit 33 and the illegal command handler 34 receives the external command CMD21.

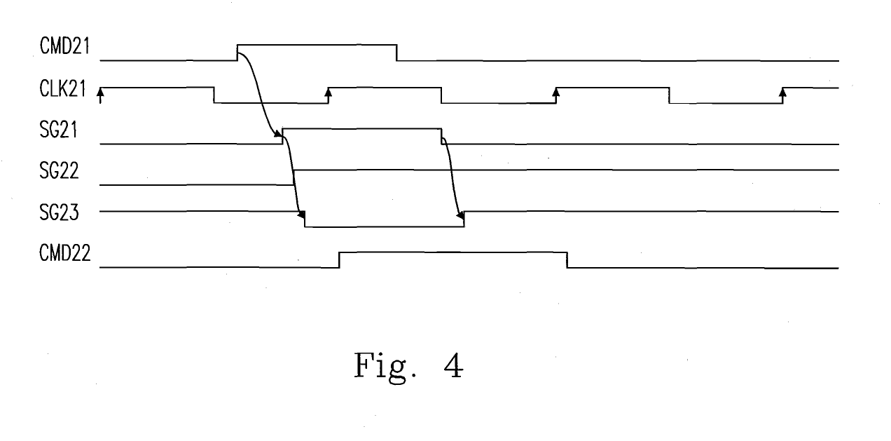

The control decode circuit 33 receives the clock signal CLK21, receives and decodes the external command CMD21, and latches the decoded external command based on the clock signal CLK21 to generate a first signal SG21. Refer to FIG. 4, which is a schematic diagram showing the waveforms in some paths of the circuit 30, the clock signal CLK21 has a positive edge and a negative edge. The control decode circuit 33 latches the decoded external command on the negative edge of the clock signal CLK21. On the other hand, the illegal command handler 34 receives the clock signal CLK21 and the external command CMD21, and generates a second signal SG22 based on whether an illegal command is detected in the external command CMD21. The second signal SG22 is at a low level if the illegal command is detected in the external command CMD21, and the second signal SG22 is at a high level if no illegal command is detected in the external command CMD21. According to FIG. 4, the waveform of the second signal SG22 is changed from a low level to a high level, which provides an example indicating no illegal command is detected.

Refer to FIG. 3, the first device 35 receives the first and the second signals SG21 and SG22, and generates a third signal SG23 based on the first and the second signals SG21 and SG22. Preferably, if the level of the second signal SG22 is low, which indicates an illegal command is detected in the external command CM21, the level of the third signal SG23 is high. And if the level of the second signal SG22 is high, which indicates no illegal command is detected in the external command CMD21, the level of the third signal SG23 will be dependent on the first signal SG21. Preferably, if the level of the second signal SG22 is high, and the level of the first signal SG21 is low, the level of the third signal SG23 is high. If the levels of both the first and the second signals SG21 and SG22 are high, the level of the third signal is low. According to FIG. 4 for instance, the level of the first signal SG21 is high and that of the second signal SG22 is high, so the level of the third signal SG23 is low.

The output circuit 36 comprises a latch circuit 361 and a second device 362. The latch circuit 361 is coupled to the first device, receives the clock signal CLK21 and the third signal SG23, and latches the third signal SG23 on the positive edge of the clock signal CLK21 to generate a first output A21. The second device 362, preferably a NOT gate, converts the first output A21 to a command output CMD22.

FIG. 4 also shows the relation in terms of timing among those signals. It can be observed that, the first signal SG21 is resulted from latching the external command CMD21 on the negative edge of the clock signal CLK21, and the command output CMD22 is resulted from latching the third signal SG23. Since the control decode circuit 33 and the illegal command handler 34 receive the external command from the second input terminal 32 simultaneously, the two functional circuits start to function at the same time. Thus, the timing loss of the present invention will be effectively reduced, compared to that of the prior art. For the output circuit 36 performs a half latch according to the clock signal CLK21, it provides a good timing window to the signals if the timing delay of the illegal command handler 34 is larger than that of the control decode circuit 33 by less than half of the full cycle time of the clock signal CLK21. Therefore, the purpose of the present invention is achieved.

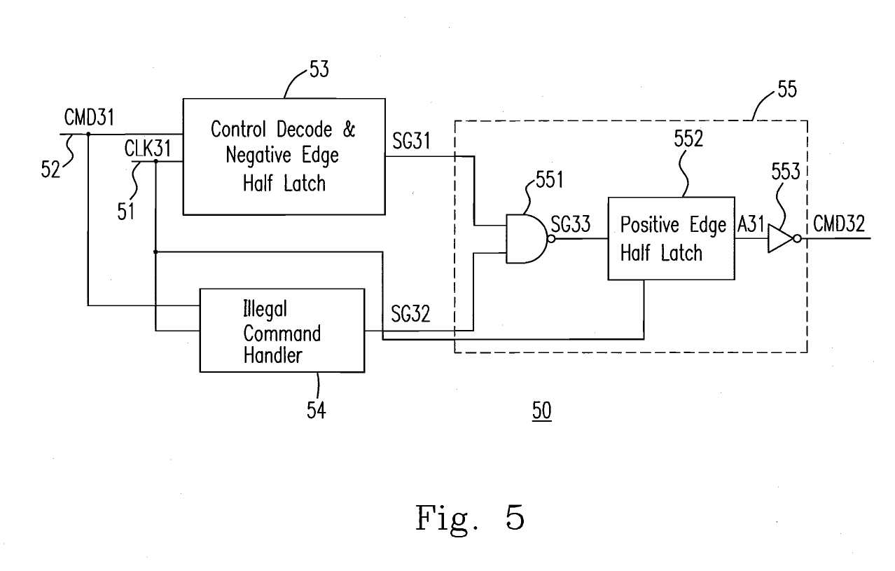

FIG. 5 is a schematic diagram showing a circuit 50 for illegal command handling according to another aspect of the present invention. According to FIG. 5, a first input terminal 51 is coupled to a control decode circuit 53, an illegal command handler 54, and an output circuit 55 respectively, and a second input terminal 52 is coupled to the control and decode circuit 53 and the illegal command handler 54 respectively. The output circuit 55 comprises a first device 551, a latch circuit 552, and a second device 553. Preferably, the first device 551 is a NAND gate and the second device 553 is a NOT gate. The first device 551 is coupled to the control and decode circuit 53 and the illegal command handler 54 respectively. The first device 551 is further coupled to the latch circuit 552. A clock signal CLK31 is provided to the first input terminal 51. The clock signal CLK31 is transmitted from the first input terminal 51 to the control decode circuit 53, the illegal command handler 54 and the output circuit 55 respectively. An external command is provided to the second input terminal 52 and is transmitted to the control decode circuit 53 and the illegal command handler 34 receives the external command CMD31.

The control decode circuit 53 receives the clock signal CLK31, receives and decodes the external command, and generates a first signal SG31. The illegal command handler 54 receives the external command CMD31 in parallel, and generates a second signal SG32 based on whether an illegal command is detected in the external command CMD31. The output circuit 55 receives the clock signal CLK31, the first and the second signals SG31 and SG32, and generates a first output A31 based on the clock signal CLK31, the first signal SG31 and the second signal SG32. The first device 551 receives the first and the second signals SG31 and SG32, and generates a third signal SG33 based on the first and the second signals SG31 and SG32. Refer to FIGS. 3 and 4, the clock signal CLK21 has a positive edge and a negative edge. The control decode circuit 53 latches the decoded external command on the negative edge of the clock signal CLK. The latch circuit 552 latches the third signal SG33 on the positive edge of the clock signal CLK31 to generate a first output A31. The second device 553 converts the first output A31 to a command output.

The fundamental concepts of how to achieve the purpose of the present invention is set forth in previous paragraphs, so it will not be repeated.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims that are to be accorded with the broadest interpretation so as to encompass all such modifications and similar structures.

What is claimed is:

1. A circuit for handling an illegal command, comprising:
a control decode circuit receiving a clock signal, receiving and decoding an external command, and latching the decoded external command based on the clock signal to generate a first signal;
a first device coupled to the control decode circuit for receiving the first signal, receiving a second signal indicating whether the illegal command is detected in the external command, and generating a third signal based on the first and the second signals; and
an output circuit coupled to the first device, receiving the clock signal and the third signal, and generating a first output based on the clock signal and the third signal.

2. The circuit as claimed in claim 1, wherein the third signal lasts a period of a full cycle time of the clock signal.

3. A circuit as claimed in claim 1, wherein the clock signal has a positive edge and a negative edge, the output circuit latches the third signal on the positive edge, and the control decode circuit latches the decoded external command on the negative edge.

4. The circuit as claimed in claim 1, further comprising:
a first input providing the clock signal;
a second input coupled to the control decode circuit, and providing the external command; and
an illegal command handler coupled to the first and the second inputs, receiving the clock signal and the external command respectively, and generating the second signal.

5. The circuit as claimed in claim 4, wherein the illegal command handler generates the second signal based on whether the illegal command is detected in the external command.

6. The circuit as claimed in claim 1, wherein the second signal is at a low level if the illegal command is detected in the external command, and the second signal is at a high level if no illegal command is detected in the external command.

7. The circuit as claimed in claim 1, wherein the first device is a NAND gate.

8. The circuit as claimed in claim 1, wherein the output circuit further comprising a second device converting the first output to a command output.

9. A circuit for handling an illegal command, comprising:
a control decode circuit receiving a clock signal, receiving and decoding an external command, and generating a first signal;
an illegal command handler receiving the external command in parallel, and generating a second signal based on whether the illegal command is detected in the external command; and
an output circuit coupled to the control decode circuit and the illegal command handler respectively, receiving the clock signal, the first and the second signals, and generating a first output based on the clock signal and the first and the second signals.

10. The circuit as claimed in claim 9, further comprising:
a first input providing the clock signals, and coupled to the control decode circuit and the illegal command handler respectively; and
a second input providing the external command, and coupled to the control decode circuit and the illegal command handler respectively, wherein the output circuit has a first device receiving the first and the second signals, and generating a third signals based on the first and the second signals, and the output circuit has a second device converting the first output to a command output.

11. The circuit as claimed in claim 10, wherein the clock signal has a positive edge and a negative edge, the control decode circuit latches the decoded external command on the negative edge, and the output circuit latches the third signal on the positive edge.

12. A method for illegal command handling, comprising steps of:
(a) receiving a clock signal and an external command;
(b) decoding the external command;
(c) latching the decoded external command based on the clock signal to generate a first signal;
(d) receiving a second signal indicating whether an illegal command is detected in the external command; and
(e) generating a first output based on the clock signal, the first and the second signals.

13. The method as claimed in claim 12, wherein the step (e) further comprising a sub-step of generating a third signal based on the first and the second signals.

14. The method as claimed in claim 13, wherein the third signal is generated based on the first signal if the second signal is at a high level, and the third signal is at a high level if the second signal is at a low level.

15. The method for illegal command handling as claimed in claim 13, wherein the step (e) further comprises a sub-step of latching the third signal based on the clock signal to generate the first output, wherein the third signal is latched on a positive edge of the clock signal.

16. The method as claimed in claim 12, wherein the decoded external command is latched on a negative edge of the clock signal.

17. The method as claimed in claim 12, further comprising a step of (f) converting the first output to a command output by inverting the first output.

18. The method as claimed in claim 12, further comprising following steps before the step (d):
(c1) receiving the external command in a parallel route;
(c2) detecting if there is an illegal command in the external command; and
(c3) generating the second signal based on a detecting result of the step (c2).

19. The method as claimed in claim 12, wherein the second signal is at a low level if an illegal command is detected in the external command.

20. The method as claimed in claim 19, wherein the second signal is at a high level if no illegal command is detected in the external command.
